(19) United States
(12) Patent Application Publication
(10) Pub. No.: US 2010/0082737 A1
(43) Pub. Date: Apr. 1, 2010

(54) DYNAMIC SERVICE ROUTING

(75) Inventors: Theodore B. Dankle, Minnetonka, MN (US); James Mattson, Excelsior, MN (US); Elena Kuznetsov, Eden Prairie, MN (US)

Correspondence Address: SCHWEGMAN, LUNDBERG & WOESSNER, P.A., P.O. BOX 2938, MINNEAPOLIS, MN, 55402, US

(73) Assignee: Carlson Marketing Worldwide, Inc.

(21) Appl. No.: 12/369,574

(22) Filed: Feb. 11, 2009

Related U.S. Application Data
(60) Provisional application No. 61/100,658, filed on Sep. 26, 2008.

(51) Int. Cl. G06F 15/16

(52) U.S. Cl. 709/203; 709/238

(57) ABSTRACT

In an example embodiment, a first message is received on a service bus which supports a plurality of disparate client applications and a plurality of disparate services. The message may be parsed to determine a requesting client application from the plurality of disparate client applications where the requesting client application is associated with one or more of the plurality of disparate services. Metadata associated with the first message may be retrieved that indicates a program identification associated with the client application and the first message may be routed to a first service from the plurality of services based on the program identification. A response may be also be received from the first service and the response may be transmitted to the requesting client application.

### RELATED APPLICATION

This application claims the benefit under 35 U.S.C. 119(e) of U.S. Provisional Patent Application Ser. No. 61/100,658 filed Sep. 26, 2008, which is incorporated herein by reference and made a part hereof.

### BACKGROUND

Service oriented architectures (SOA) define a group of services that communicate with each other. SOA separates functions into distinct units, or services, which are made accessible over a network in order that they can be combined and reused in the production of business applications.

### BRIEF DESCRIPTION OF THE DRAWINGS

Some embodiments are illustrated by way of example and not limitation in the figures of the accompanying drawings in which:

FIG. 1 is an example system diagram of a point-to-point system.

FIG. 2 is an example system diagram of a bus oriented system.

FIG. 3 is an example diagram of an enterprise service bus architecture.

FIG. 4 illustrates a system overview of an example embodiment of a global services connector (GSC) routing framework

FIG. 5 illustrates an example of a federated enterprise service bus.

FIGS. 6A and 6B illustrate example client/service interaction.

FIG. 7 illustrates an example data structure diagram of a program solution.

FIG. 8 illustrates a example dataflow diagram.

FIG. 9 illustrates an example data structure diagram of variables included in the metadata.

FIG. 10 is an example system computer diagram.

### DETAILED DESCRIPTION

In a multi-tenant service environment, the system provider may offer a variety of services or business solutions to many clients at the same time with each utilizing the services in different ways. For example, a business solution may relate to a marketing reward program that enables a client to establish a program that rewards its customers or employees with points that may be redeemable for goods or money. Although a specific client business solution may be similar in function to other hosted client solutions, it may provide differentiation from competing marketing reward programs, including those hosted by the same system provider. In addition, a business solution that spans multiple countries may need to embody services that will differ by locality—to accommodate local customs and regulations.

In an example embodiment, a solution may be the set of disparate services a client may use as well as the interactions between those services. For example, in a consumer marketing reward program, the set of services may be defined as: Earnings, Point Banking, Participation, Program Management and Member Communications. The process of rewarding consumer's may involve: The Earnings Service to determine value; The Point Banking Service to store accrued value; The Participation Service to identify the consumer; The Program Management Service to identify the client program; And the Member Communications Service to notify the consumer of the rewards.

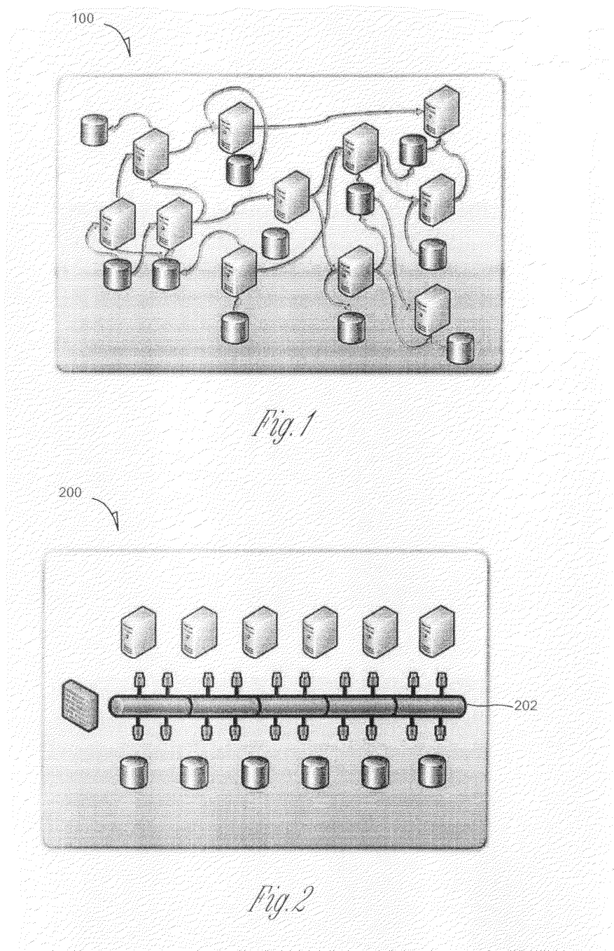

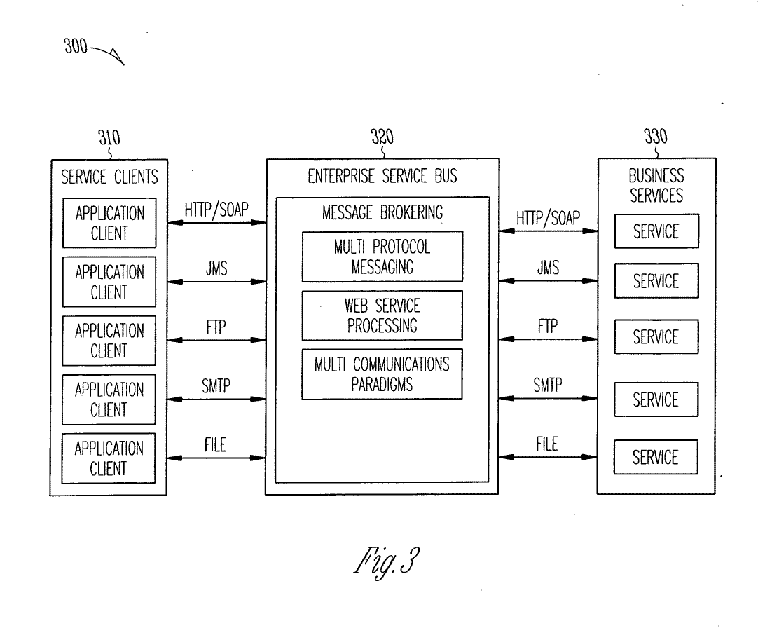

Also, clients may use the same underlying services, but require different interfaces to communicate with the service. This may require the provider to implement redundant functionality. An example of this type of system is illustrated in FIG. 1. It illustrates a point-to-point system in which each computer may be coupled to many other computers in the system. However, a system 100 such as illustrated in FIG. 1 may be required to be built and maintained for each client. As such, if a provider introduces a new service, the potential exists for the provider to have to modify each and every client's solution to allow interfacing with the new service. This may also be true if a service has been updated. Traditionally, this would involve hard coding the changes for each client and may be very time consuming depending on the changes and the number of clients.

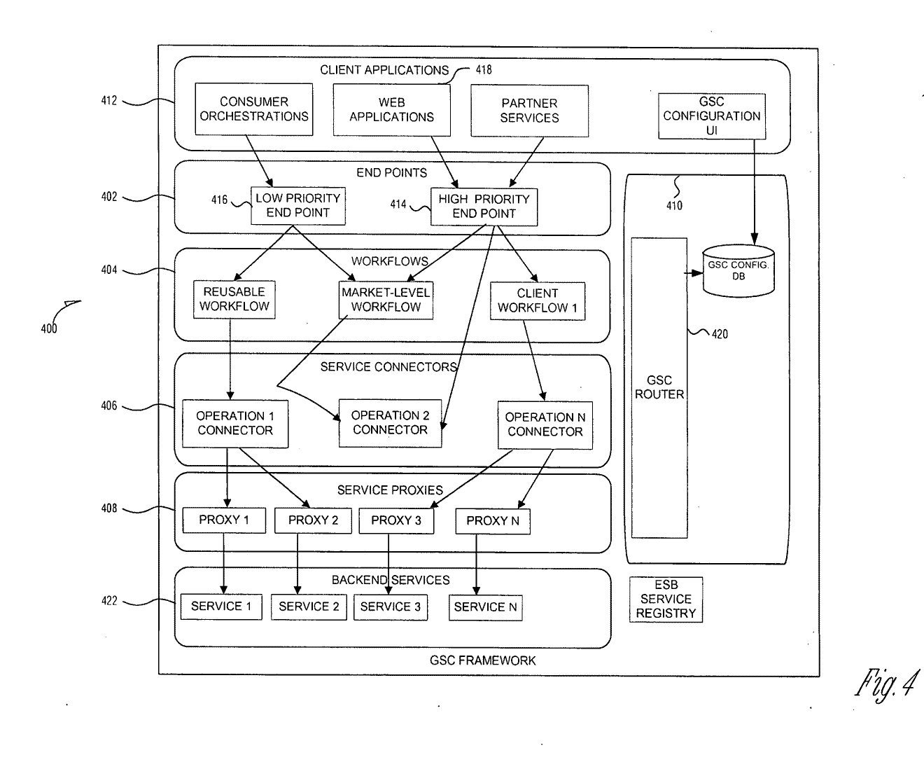

In an example embodiment, the provider implements a global service connector (GSC) routing framework to help reduce this redundancy where possible. This framework may provide a consistent yet flexible approach for designing, implementing and publishing service connectors and service orchestrations using a GSC bus (sometimes referred to as a service bus). In an example embodiment a service connector allows two otherwise inoperable components of the framework to communicate with each other. The framework may provide functionality that is needed for creating a pluggable, highly controlled enterprise service bus architecture. It may establish design patterns necessary for establishing consistent use, simplifying maintenance, reducing client impact due to service migration or service interface change, establishing basic governance policies/procedures for a multi-tenant service runtime environment. Some of the services that may be available to clients/users of the GSC framework include earning, accrual of non-monetary marketing program currencies, participation, communications, program, catalog, item, certificate, and order services. FIG. 2 illustrates a high level diagram of a system 200 using a service bus 210 that, in contrast to FIG. 1, allows the computers to communicate to each other through the bus 210 instead of in a point-to-point to configuration.

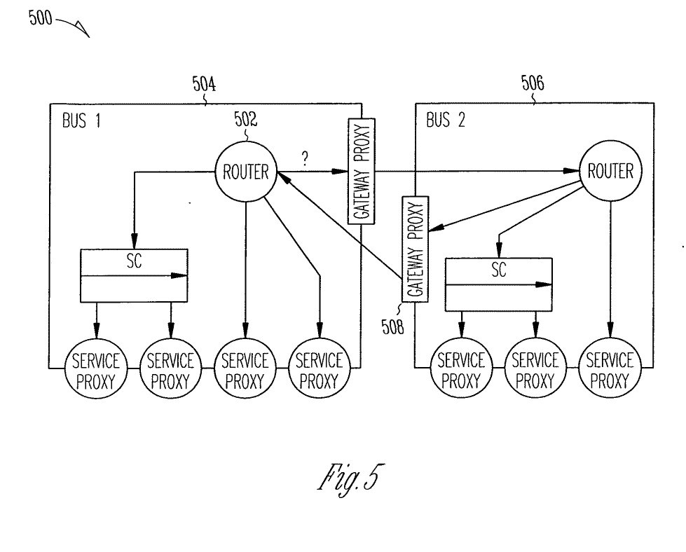

FIG. 3 illustrates, in example embodiment, an implementation of a service bus such as illustrated in FIG. 2. As can be seen there are one or more clients 310, that communicate with the service bus 320 to access services 330. Also shown are the multiple ways in which the clients 310, bus 320, and services 330 may communicate with each other. These communications protocols may include, but are not limited to Hypertext Transfer Protocol (HTTP), Simple Object Access Protocol (SOAP), Java Messaging Service (JMS), File Transfer Protocol (FTP), or Simple Mail Transfer Protocol.

In an example embodiment, the GSC framework may include many features including, but not limited to: routing, routing transport protocols, messaging, message types, transformations, testing, logging and monitoring, versioning, service level agreements, security, resource repository, and error handling. The routing features may allow routing of messages according to XQuery-based (A query language designed to query collections of XML data, similar to SQL) policies or callouts to external services. Routing policies may apply to both point-to-point and one-to-many routing scenarios (publish). For publishing, routing policies may serve as subscription filters. The routing transport protocols may include, but are not limited to, file, FTP, HTTP(S), JMS (including MQ using JMS, and JMS/XA), and E-mail (POP/SMTP/IMAP).

In an example embodiment, messaging models may include, but are not limited to, synchronous, asynchronous, publish, and subscribe. The messaging types may include, but are not limited to, the following formats: E-mail with or without attachments, JMS with headers, Message Format Language (MFL), Raw Data (opaque data with no known schema), Text, SOAP and SOAP with attachments (SOAP that is or is not described by a web service definition language (WSDL).

In an example embodiment, the framework may support many forms of functionality for the transformation or processing of messages. It may validate incoming messages against schemas, select a target service or services based on the message content or message headers, transform messages based on the target service, transform message based on XQuery or XSLT, and support transformations on both XML and MFL messages.

In an example embodiment, the testing component of the framework may provide a built-in test console allowing the testing of resources and inline XQuery expressions used in the message flow and test business services and proxy services. It may also provide tracing of message flow when a service is tested using the test console.

In an example embodiment, the framework may provide a functionality related to logging and monitoring to audit the services. For instance, it may provide statistics about message invocations, errors, performance characteristics, messages passed, service level agreements (SLA) violations, etc. The system may also support logging selected parts of messages for both systems operations and business auditing purposes, search capabilities, etc. The ability to extract key information from a message and use as it as a search index may be included in the framework. A console may provide a cluster-wide service status and statistics. Both business services and Service Bus proxy services may be monitored, as may be response times, message counts, and error counts. The statistics may be gathered locally and aggregated centrally. SLA rules may run against the aggregated data and the framework may raise alerts allowing enabling or disabling of the services.

In an example embodiment, versioning may provide the ability to deploy new versions of services and allow you to have multiple versions of message resources such as WSDLs and schemas. Versions may include changes to the WSDL, the message schema, the headers, and the security parameters.

In an example embodiment, administrators of the framework may set SLA on various attributes of proxy services including, but not limited to: average processing time of a service, processing volume, and number of errors, security violations, and schema validation errors. An administrator may also configure alerts for SLA rule violations.

In an example embodiment, many security features may be supported as well. For example the framework may support authentication, encryption and decryption, and digital signatures as defined in the Web Services Security (WS-Security) specification. It may use SSL to support traditional transport-level security for HTTP and JMS transport protocols. It may also support one-way and two-way certificate based authentication as well as HTTP basic authentication.

In an example embodiment, the resource repository is responsible for many management aspects of the framework. It may store information about services, schemas, transformations, WSDLs (Web Service Definition Language), and WS Policies. It may provides centralized management and distributed access to resources and services. It may allow a user to browse registered services and import resources from other applications. Additionally, it may allow the propagation of configuration data from environment to environment (for example, from development to test to a production domain). The system allows environment specific settings to be overridden during import. It may also provide interoperability with universal description, discovery and integration (UDDI) registries—one may publish a service to and import a business service from version 3-compliant UDDI registries.

In an example embodiment, one aspect of the error handling allows a person to configure the system to format and send error messages, and return messages for consumers of services who expect a synchronous response. It also allows a person to configure error handling for stages in the pipeline, for pipelines, and for proxy services.

### Example Framework Structure

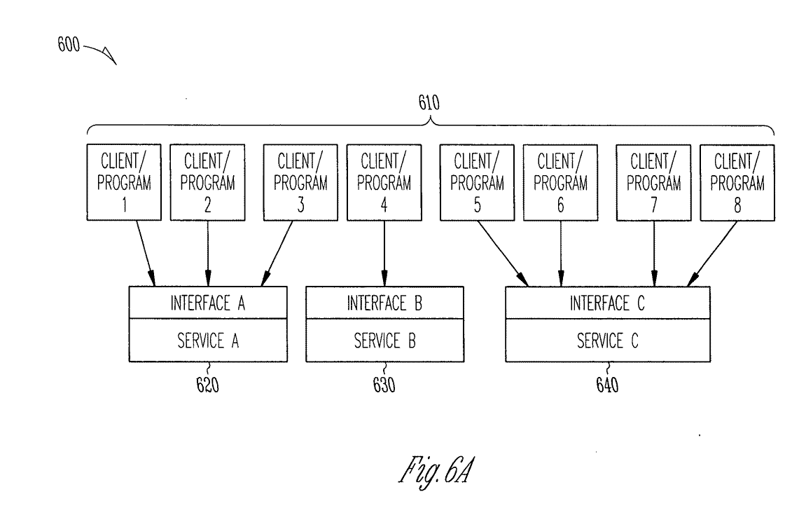

FIG. 4. illustrates a system overview of an example embodiment of a global services connector (GSC) routing framework 400 utilizing an enterprise service bus (ESB). Shown are multiple example client solutions. The GSC framework may have five basic layers (component types). The framework components are part of the framework, but not all of the layers need to be used in every operation. The diagram shows the various logical layers and the associated components that may be included in the framework. In an example embodiment, in the absence of a comprehensive service registry, the identities and configuration of the services published on the service bus may be stored in a relational data store. FIG. 4 illustrates a global endpoint layer 402, a workflow layer 404, a service connector layer 406, a service proxy layer 408, a routing layer 410, and a backend services layer 422.

In an example embodiment, the GSC Global endpoints 414, 416 are the only points of the ESB accessible from the outside (e.g., public users/web/client applications 412 of the system). As such, the number of endpoints should be minimized and each should be properly secured. In some example embodiments, the endpoints provide access to a plurality of backend services by receiving messages from a plurality of client applications. In an example embodiment, the endpoint layer 402 is further configured to receive a first message from a requesting client application, the requesting client application associated with or more of the plurality of backend services. In an example embodiment, the endpoint layer 402 is further configured to concurrently accept a plurality of messages from the plurality of client applications.

In an example embodiment, there are two endpoints, one for high priority requests 414 and one for low priority requests 416. This may be done to ensure that those requests that are the highest priority for the business or client are given the most effective use of bus resources, rather than trying to deliver the same level of quality of service to all requests. Some requests, such as a transaction submitted by a File Management System (FMS) processes, might not be given high priority. If a failure occurs, the requests may be sent again. Synchronous requests from a web site application or other user interface may be delivered across the bus with the highest level of service. In an example embodiment, batch processes use the lower priority end point where user interface and other web applications 418 should use the higher priority endpoint 414.

The responsibilities of a global endpoint may include assigning a globally unique enterprise service bus (ESB) tracking id, initiating ESB invocation stack by entering its proxy id, and forwarding requests to the framework router. The ESB tracking number may be a unique number that is assigned to a request when it is enters the boundaries of the ESB. The number may remain unchanged until the response is dispatched back (true for synchronous and asynchronous invocation modes). Further, each endpoint may be associated with a Java (v2) Enterprise Edition Server (J2EE) Application Server work manager to achieve proper thread priority management. Other suitable programming languages may be used as well as on skilled in the art will recognize. In an example embodiment, each endpoint will have a timeout setting that makes sure that services deployed on the bus satisfy the response time SLA that needs to be in place to publish service in a shared enterprise bus environment. The synchronous operations that require longer timeout settings may also need to be accessed via the lower priority end point.

In an example embodiment, workflow layer 404 is configured to provide access to one or more workflows, the workflows defining one or more operations associated with the plurality of client applications. In an example embodiment, workflows in the workflow layer 404 are aggregated services that are created by orchestrating two or more service operations/calls. The responsibilities of workflows may include building individual requests according to extensible markup language (XML) schema/web services definition language (WSDL), and dispatching the requests via a router callout. A workflow may be a sequence of web service calls (invocations) and XML transformations. Workflows may involve conditional logic to determine the next service call.

In an example embodiment, the service router 420 in the router layer 410 is the component that is used for each service invocation in GSC framework 400. In an example embodiment, the service router is configured to dynamically route the received messages to the appropriate backed service based on metadata associated with the message. In further example embodiments, the service router 420 is further configured to detect a first message from the received messages. Metadata associated with the first message may be retrieved, the metadata including a program identification associated with a first workflow from the one or more workflows. In an example embodiment, an operation associated with the first workflow is identified, the operation including a first backend service call. The first message may be routed to the first backend service. In an example embodiment the service router supports routing messages synchronous and asynchronous. Asynchronous routing may allow the router to send a first message to a backend service and proceed to send another message without needing to receive a response from the first message.

Global endpoints and workflows 404 invoke service proxies 408 with or without service connectors 406 by forwarding the request to the GSC Router 420. In an example embodiment, there is a single router 420 component on the ESB. However, if the bus is federated into multiple buses, there may be a router for each bus. Some of the responsibilities of the router may include discovering requested services (program operation) on the ESB, augmenting the ESB invocation stack trace every time the request is routed, analyzing the depth of the ESB stack to prevent ‘dead’ messages that otherwise may be forwarded from service to service indefinitely, and updating a ESBServiceProxy parameter to be used by the Service Connectors.

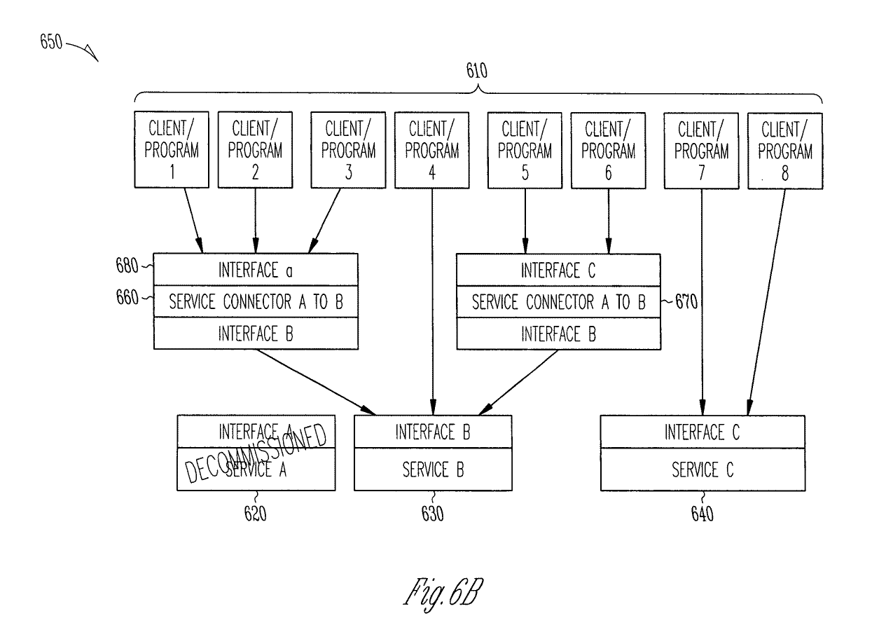

If the bus is federated into a system of buses, a gateway component may be used to route requests from one bus to another. FIG. 5 illustrates an example embodiment of such a system 500. A first router 502 on a first bus 504 may recognize that a service is published on a second bus 506 and forward it to the gateway component 508 that would route it further to the appropriate endpoint (not shown) on the corresponding bus. FIG. 5 also suggests that there is an element of control as how the requests the services are accessed (e.g., the gateways do not have to be enabled in both directions).

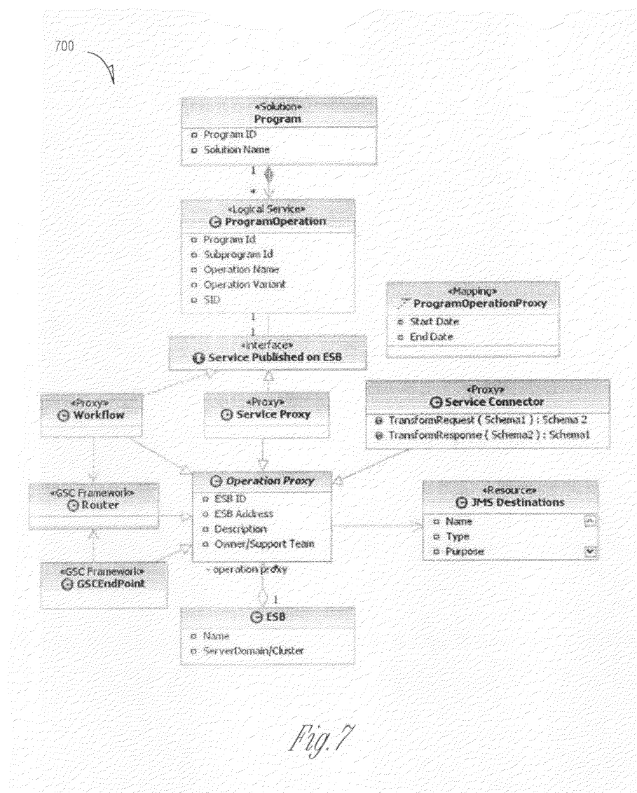

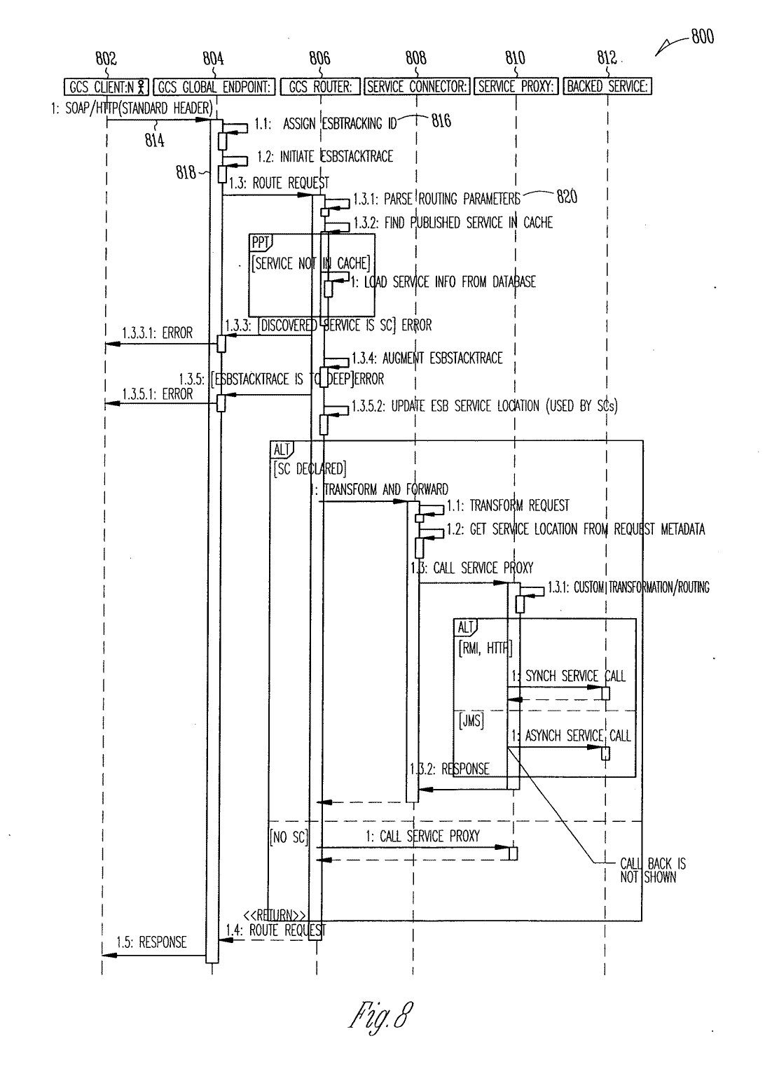

In an example embodiment, the service connectors in the services connectors layer 406 are introduced to client/port interfaces. They may be used in different scenarios. For example, the service connector may be used to minimize impact of operation changes and/or service migration on client systems/application. This is illustrated with reference to FIG. 6A and FIG. 6B. FIG. 6A illustrates a more traditional system 600 with no translations between services using different interfaces. There are eight example clients/programs 610 with clients 1, 2, and 3 using service A 620, client 4 using service B 630, and clients 5, 6, 7, and 8 using service C 640. In FIG. 6B illustrating system 650, clients 1, 2, 3, 5, and 6 have been migrated to service B 630. The use of service connectors 660 and 670 allow for easy migration to service B 630. Without the use of service connectors, the process of migrating to service B 630 may have required duplicating the functionality of service B 630 as to interface with Interface A 680. This may greatly increase the efficiency of upgrading or replacing services.

Referring back to FIG. 4, in an example embodiment, service proxies in the service proxies layer 408 are used to publish the backend services 422 on the ESB. In an example embodiment, the service proxy layer is configured to provide access to one or more service proxies that are mapped to the backed services. Some of the responsibilities of the service proxies may include performing transformation between different versions of its interface, performing custom routing, and invoking backend services using the appropriate protocol. They may also perform transformation from the interface used by ESB clients and the interface that is used by the backend service (request and response). This may be needed in cases when the back end service interface is not suitable for publishing on the bus for any reason (incompatible vocabulary, interface not based on XML schema, etc.) In an example embodiment, the plurality of backend services include earning, accrual of non-monetary marketing program currencies, participation, program management, and member communication services. In an further example embodiment, the plurality of backend services enable a marketing reward program to be utilized by the plurality of client applications.

### Example Uses of the Framework

Each client of the framework will have different needs for different services and may have different requirements for those services. In an example embodiment, the end result is that a program solution should be delivered to the client as a set of operations that are needed to enable development of web applications, batch processes, and other systems that will act as clients from the ESB's prospective (e.g., a web application may be considered a client to the ESB). The required operations may be identified by someone knowledgeable about the framework (e.g., a solutions architect). Once the operations are identified, they may be either implemented or mapped to existing services.

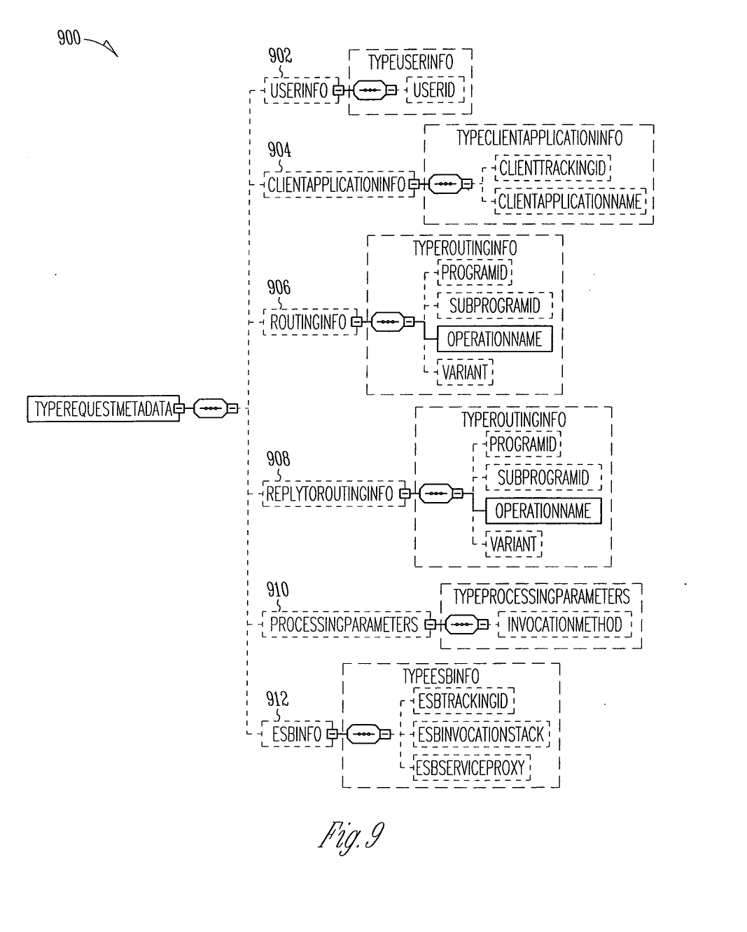

If the operation is not new in the service landscape, the solutions architect may choose among a few options. However, these options are exemplary only. For example, he/she may use existing service operations existing in the service interface and the client apps/systems may adopt the existing interface. Similarly, one may use existing services/operations by mapping client interfaces to a standard interface via use of a service connector. This may be used if the client/system cannot be adapted to use existing interface. Another option may be to develop a workflow that can be custom or reusable. A workflow is an ESB component that, in some instances, orchestrates two or more service invocations. The workflows may be considered services published on the ESB. From the client prospective there is no difference between a workflow and a back-end service published on ESB. Reusable workflows may be used for more than one program solution and service connectors can be used to map client system interface to the workflow service interface if needed. Illustrated in FIG. 7, is an example diagram of program solution data structure 700. As can be seen, there may be multiple program operations for each solution.

Similarly, in a service oriented architecture (SOA) environment the solution architect assembles the solution from the services that are available in a company SOA. In an example embodiment, the services should be built as snappable, pluggable, swappable, etc. In some example embodiments, it may be possible to build s super-interface to make everything pluggable to it, but that may lead to a number of very bloated, very purely structured interfaces that have duplicate elements, overloaded elements and elements that seem to be out of place for the interface. Although the creation of the super-interface may be a good idea in some cases it may not be ideal. In a further example embodiment there is a creation of common/standard interfaces that allow for more reuse in client systems and service orchestrations. Similarly the architects and designers should use service connectors wisely so that the SOA interfaces stay clean and ‘usable.’

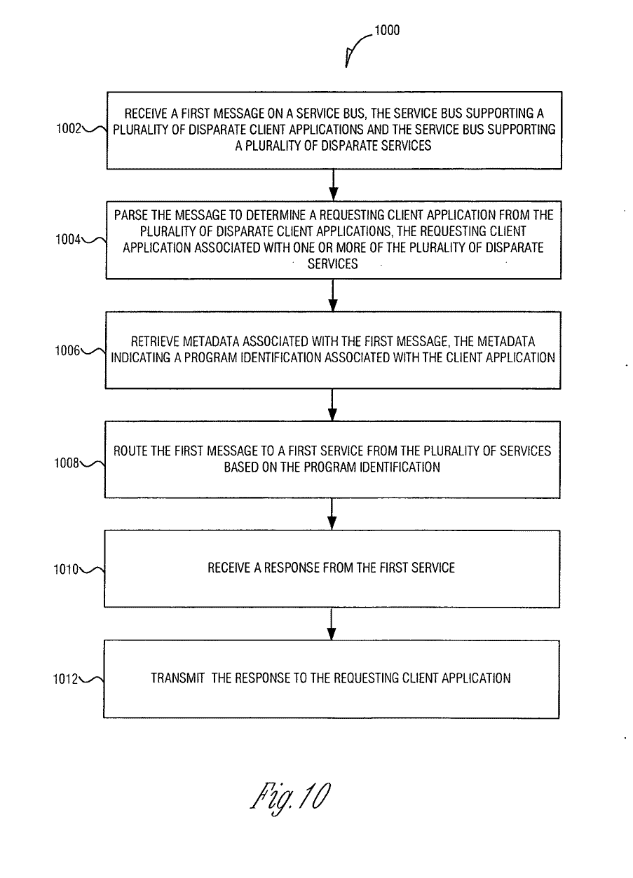

In an example embodiment, FIG. 8 illustrates a dataflow diagram 800 that tracks a message request being sent from a client 802 through the GSC framework and back to the client. Across the top is a client 802, an endpoint 804, a router 806, a service connector 808, a service proxy 810, and a backend service 812. These components may be similar to those described with reference to FIG. 4. FIG. 8 illustrates time generally starting and continuing to the bottom. At 814, a message is received on the service bus from a client application, the service bus being communicatively coupled to a plurality of services. This message may be received at one of the global endpoints that are publicly accessible. At 816, the message is assigned an ESBTracking ID. At 818, in an example embodiment the message request is routed to the appropriate service. This may be done by retrieving metadata for the message. The metadata may be parsed 820 to determine where the message should next be sent.

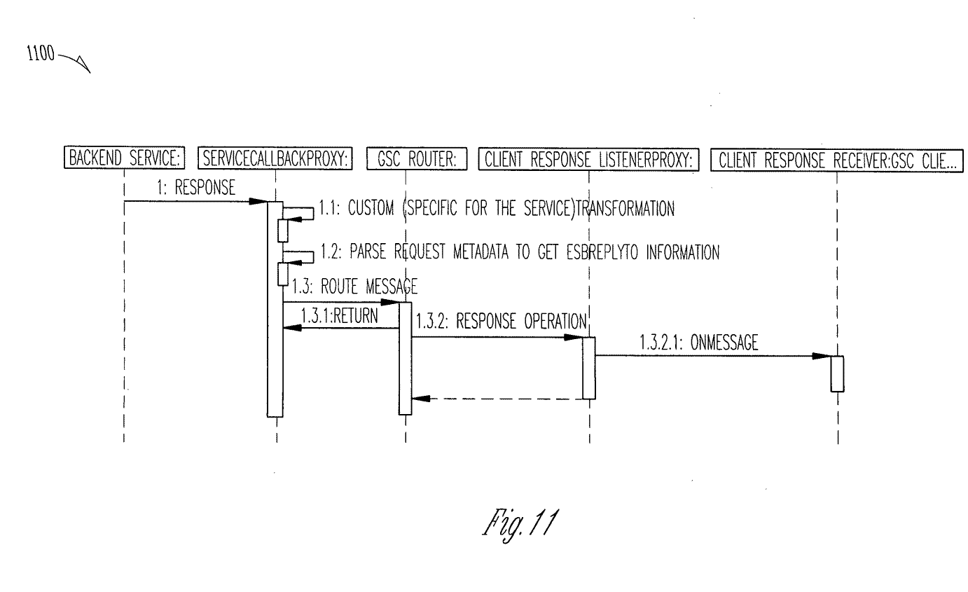

An example diagram 900 of what the metadata may contain is illustrated in FIG. 9. As can be seen, there is some similarity between the metadata in FIG. 9 and the program solution data structure illustrated in FIG. 7. The metadata data structure may include, but is not limited, to:

UserInfo—This data item may contain a UserID variable. This set may contains the actual user's identification token—the “user id.”

ClientApplicationInfo This data item may include ClientTrackinglD and ClientApplicationName variables. This set may contain internal reference information about the calling system, such as which button was clicked to invoke this service.

RoutingInfo—This data item may include ProgramID, SubProgramID, OperationName, and Variant variables. This set may contain all the information required to ROUTE messages—including: The ProgramId which may identify the specific client marketing program from the caller; The SubProgramId which provides more “granularity” regarding the specific client marketing program—for example, a client might have two very similar programs—one for chevy cars and the other for cadillacs; The OperationName defines the service call—for example “getPointBalance” or “enrollInProgram”; The Variant field may be used to provide additional routing information that is variable from program to program.

ReplytoRoutingInfo—This data item may include ProgramID, SubProgramID, OperationName, and Variant variables. This set may contain the same information as the previous set (RoutingInfo) and is used as a “callback” mechanism: a means of specifying how a downstream asynchronous service should return information. In an example embodiment, an “Asynchronous” service is different from a synchronous service in that a synchronous service returns “computational” results upon completion whereas an asynchronous service will immediately return only information about whether the downstream service was started successfully.

ProcessingParameters—This data item may include an InvocationMethod variable. This set may contain an InvocationMethod field which specifies whether the service should be called Asynchronous or Synchronous.

ESBInfo—This data item may include an ESBTrackingID, an ESBInvocationStack, and ESBServiceProxy variables. This set contains the fields described above and may be used for diagnostic purposes to track messages that are sent within the Framework.

In an example embodiment, the metadata for the message represents a part of the program solution for the client which may allow the framework to dynamically transform the message in a deterministic way through a metadata-enabled, policy driven environment. Without the metadata, the system may need to be implemented in such a way that every client's solution would have to be hard coded. The metadata may allow the router to intelligently route message through the framework to the relevant services based on changing conditions. The framework may examine the RoutingInfo to see what operation the framework should invoke. This may include identifying a service associated with the message. The framework may check to see if the service has been loaded, and if not, load the service. In an example embodiment, the framework will then route the message to the service. The routing may involve using a service connector, if needed. If a service connector is used the message may be transformed to ensure proper interoperability as discussed above. The service may be called using the appropriate service proxy. A response may be sent back to bus and then the next operation may be called until eventually a response is sent back to the client.

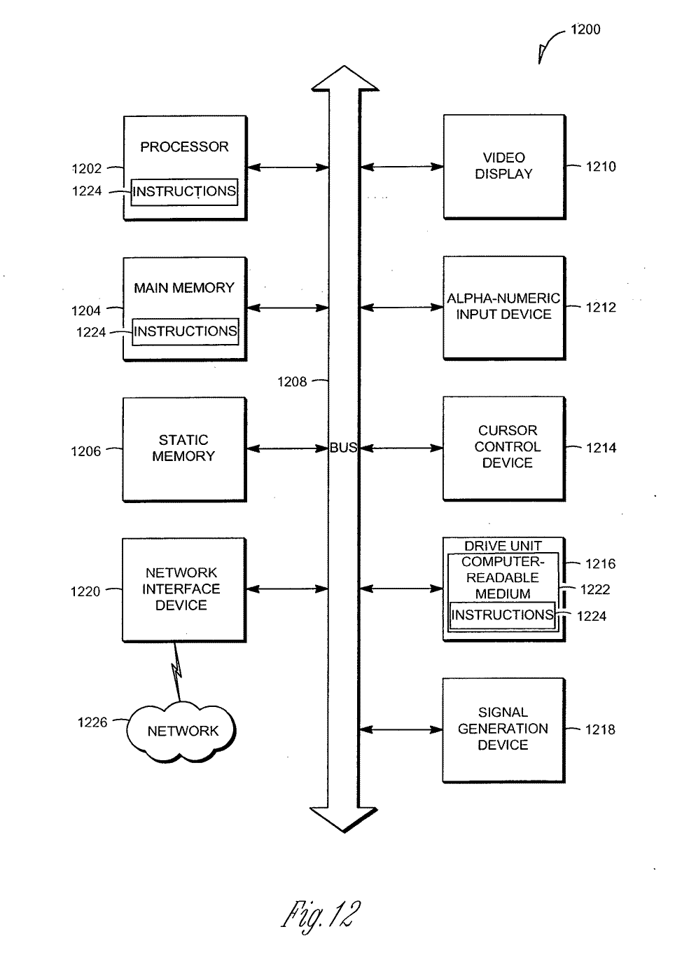

FIG. 10 illustrates an example method of using the framework to route messages from disparate client applications. At block 1002, in an example embodiment, a first message is received on the service bus, the service bus supporting a plurality of disparate client applications and the service bus supporting a plurality of disparate services. In further example embodiments, a second message may be concurrently received on the service busy from a second client application. In some example embodiments, the plurality of disparate services include earning, accrual of non-monetary marketing program currencies, participation, program management, and member communication services. The disparate services may enable a marketing reward program. Enabling may mean providing a framework in which a company may offer a marketing reward program to either employees or consumers. In further example embodiments, the plurality of disparate client applications and disparate services may be external to the service bus.

At block 1004, in an example embodiment, the message is parsed to determine a requesting client application from the plurality of disparate client applications, the requesting client application associated with one or more of the plurality of disparate services.

At block 1006, in an example embodiment, metadata associated with the first message is retrieved, the metadata indicating a program identification associated with the client application. If a second message has been received, metadata associated with the second message may be retrieved, the metadata indicating a program identification associated with the second message. In an example embodiment, the metadata may include a marketing reward program associated with one or more of the plurality of disparate client applications.

At block 1008, in an example embodiment, the first message is routed to a first service from the plurality of services based on the program identification. If a second message has been received, the second message may be routed to a second service from the plurality of services based on the program identification associated with the second message. In an example embodiment, routing the first message or second message may be done synchronously or asynchronously. Routing the first message using asynchronous message may include attaching response metadata to the first message, the response metadata including the program identification associated with the first message. An example of asynchronous messaging may be seen with reference to FIG. 11. Asynchronous messaging may allow the framework to process messages in a more efficient manner as the framework may not wait for a response from the routed to service before processing the next message. The response metadata may allow the system to see which client application the response is associated with to determine where to route the response message next. Further example embodiments of routing messages may include retrieving a version of the service being routed to from the metadata and routing the message to the appropriate version of the service based on the metadata.

At block 1010, in an example embodiment, a response from the first service is received. In some example embodiments, a workflow associated with the metadata is retrieved upon receiving the response from the first service. The response from the first service may be compared with the workflow associated with the metadata. Based on the response, the first message may be routed to a second service from the plurality of services. If a second message has been received, the metadata associated with the second message may include a workflow associated with the second client application upon which to determine where to route any further responses associated with the second message.

At block 1012, in an example embodiment, the response is transmitted to the requesting client application. In this manner the client application may then use the data or information received and display it to a user of the client application. In some example embodiments, the client application is requesting access to the ESB with no interaction by a user. For example, a company may wish to have an automated back up process.

### A Computer System

FIG. 12 shows a diagrammatic representation of a machine in the example form of a computer system 1200 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment or as a peer machine in a peer-to-peer (or distributed) network environment. The machine may be a Personal Computer (PC), a tablet PC, a Set-Top Box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems which are linked (e.g., either by hardwired, wireless, or a combination of hardwired and wireless connections) through a network both perform tasks. In a distributed system environment, program modules may be located in both local and remote memory-storage devices (see below).

The example computer system 1200 includes a processor 1202 (e.g., a Central Processing Unit (CPU), a Graphics Processing Unit (GPU) or both), a main memory 1204 and a static memory 1206, which communicate with each other via a bus 1208. The computer system 1200 may further include a video display unit 1210 (e.g., a Liquid Crystal Display (LCD) or a Cathode Ray Tube (CRT)). The computer system 1200 may also includes an alphanumeric input device 1mk (e.g., a keyboard), a User Interface (UI) cursor controller (e.g., a mouse), a disc drive unit 1216, a signal generation device 1218 (e.g., a speaker) and a network interface device (e.g., a transmitter) 1220.

The disc drive unit 1216 includes a machine-readable medium 1222 on which is stored one or more sets of instructions 1224 and data structures (e.g., software) embodying or utilized by any one or more of the methodologies or functions illustrated herein. The machine-readable medium may be a computer-readable medium. The software may also reside, completely or at least partially, within the main memory 1204 and/or within the processor 1202 during execution thereof by the computer system 1200, the main memory 1204 and the processor 1202 also constituting machine-readable media.

The instructions 1224 may further be transmitted or received over a network (e.g., the INTERNET) 1226 via the network interface device 1220 utilizing any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A computer implemented method, the method comprising:
receiving a first message on a service bus, the service bus supporting a plurality of disparate client applications and the service bus supporting a plurality of disparate services;
parsing the message to determine a requesting client application from the plurality of disparate client applications, the requesting client application associated with one or more of the plurality of disparate services;
retrieving metadata associated with the first message, the metadata indicating a program identification associated with the client application;
routing the first message to a first service from the plurality of services based on the program identification;
receiving a response from the first service; and
transmitting the response to the requesting client application.

2. The computer implemented method of claim 1, further comprising:
retrieving a workflow associated with the metadata upon receiving the response from the first service;
comparing the response from the first service with the workflow associated with the metadata; and
routing the first message to a second service from the plurality of services based on the response.

3. The computer implemented method of claim 1, wherein routing the first message includes routing the first message using asynchronous messaging.

4. The computer implemented method of claim 3, wherein routing the first message using asynchronous messaging includes attaching response metadata to the first message, the response metadata including the program identification.

5. The computer implemented method of claim 1, wherein routing the first message includes routing the first message using synchronous messaging.

6. The computer implemented method of claim 1, further comprising:
concurrently receiving a second message on the service bus from a second client application;
retrieving metadata associated with the second message, the metadata indicating a program identification associated with the second message; and
routing the second message to a second service from the plurality of services based on the program identification associated with the second message.

7. The computer implemented method of claim 6, wherein the metadata associated with the second message includes a workflow associated with the second client application.

8. The computer implemented method of claim 1, wherein routing the first message to a first service includes:
retrieving a version of the first service from the metadata; and
routing to the version of the first service retrieved from the metadata.

9. The computer implemented method of claim 1, wherein the plurality of disparate services include earning, accrual of non-monetary marketing program currencies, participation, program management, and member communication services.

10. The computer implement method of claim 1, wherein the plurality of disparate services enable a marketing reward program.

11. The computer implemented method of claim 1, wherein the plurality of disparate client applications include client applications external to the service bus and wherein the plurality of disparate services include services external to the service bus.

12. The computer implemented method of claim 1, wherein the metadata includes a marketing reward program associated with one or more of the plurality of disparate client applications.

13. A system comprising:
an endpoint layer configured to provide one or more endpoints, the endpoints providing access to a plurality of backend services by receiving messages from a plurality of client applications;
a workflow layer configured to provide access to one or more workflows, the workflows defining one or more operations associated with the plurality of client applications;
a service proxy layer configured to provide access to one or more service proxies, the service proxies mapped to the plurality of backend services; and
a service router, the service router configured to dynamically route the received messages to the appropriate backend service based on metadata associated with the messages.

14. The endpoint layer of claim 13, further configured to concurrently accept a plurality of messages from the plurality of client applications.

15. The endpoint layer of claim 13, further configured to receive a first message from a requesting client application, the requesting client application associated with one or more of the plurality of disparate services

16. The service router of claim 13, further configured to route the received messages using asynchronous messaging.

17. The service router of claim 13, further configured to route the received messages using synchronous messaging.

18. The service router of claim 13, further configured to:
detect a first message from the received messages;
retrieve metadata associated with the first message, the metadata including a program identification associated with a first workflow from the one or more workflows;
identify an operation associated with the first workflow; the operation including a first backend service to call; and
route the first message to the first backend service.

19. The system of claim 13, wherein the plurality of backend services include earning, accrual of non-monetary marketing program currencies, participation, program management, and member communication services.

20. The system of claim 13, wherein the plurality of backend services enable a marketing reward program to be utilized by the plurality of client applications.
